(19) United States
(12) Patent Application Publication
(10) Pub. No.: US 2008/0243673 A1
(43) Pub. Date: Oct. 2, 2008

(54) Methods to improve accuracy and precision of timestamps for financial data

(76) Inventors: Ralph Bruce Ferguson, Round Rock, TX (US); Thomas Neal Falkenberry, Great Falls, VA (US)

Correspondence Address: RATNERPRESTIA, P O BOX 980, VALLEY FORGE, PA, 19482-0980, US

(21) Appl. No.: 11/728,562

(22) Filed: Mar. 26, 2007

(51) Int. Cl. G06Q 40/00

(52) U.S. Cl. 705/37; 700/14; 705/418

(57) ABSTRACT

A method for producing a timestamped series of price data of a financial instrument from its prices. The timestamped series includes a timestamp associated with each price. Each timestamp has a timestamp precision of one millisecond or less and a timestamp accuracy equal to or shorter than the timestamp precision. At least one timestamping processor is provided to receive the prices. The internal clock of each timestamping processor is synchronized to a universal time with a time precision and accuracy equal to or shorter than half of the timestamp precision. Each price is applied to a timestamping processor with a predetermined time delay after quotation. Each time delay has a time delay precision and accuracy equal to or shorter than half of the timestamp precision. The timestamp is determined for each applied price based on the corresponding delay time and internal time when the price is applied.

### FIELD OF THE INVENTION

The present invention concerns a system and method for improving the accuracy and precision of timestamps for financial data. In particular, this method may allow for improved timestamping of bid and ask prices of financial instruments from multiple exchanges and may be used to provide information to make decisions for automated trading of various financial instruments.

### BACKGROUND OF THE INVENTION

The best technique for making money though investing in financial instruments may be summed up in four small words: buy low, sell high. A successful investor is someone who can buy low and sell high enough to come out ahead at the end of their transactions. For example, in stock investing, there are three basic investment strategies to which investors commonly subscribe in their efforts to try to buy low, sell high: (1) pure fundamental analysis, (2) pure technical analysis, and (3) a combination of fundamental and technical analysis.

### 1. Fundamental Analysis Strategy

Otherwise known as the value method of investing, a fundamental analysis strategy is the investment in stocks on the basis of the value of the companies represented by the stocks. The company's balance sheet, income statement, etc., are studied to help determine the financial and market position of the company. If the analysis of the company's historic growth and profit patterns shows a steadily growing organization, and the research of the organization and its markets show a company that is competent and sound, a fundamental analysis approach may conclude that the company should continue to grow and prosper in the future.

### 2. Technical Analysis Strategy

The technical analysis strategy is a favorite of market timers. These are investors who try to make profits based on the short-term swings of the market. Common market timers range from day traders, who try to take advantage of hourly or daily price changes to make a profit, to slightly longer-term investors who track stock price and trading volume fluctuations over a period of a few days or weeks and trade on the basis of recent trends. As opposed to fundamental analysis where the emphasis is on the strength of the underlying corporation, technical analysis focuses on patterns that appear on the historical price charts of a specific stock and of the stock market in general in order to help predict the future of that stock's price. This strategy is based on the theory that certain patterns of stock prices tend to repeat themselves over time.

### 3. Combination Fundamental and Technical Analysis Strategy

A third investment strategy combines elements of both fundamental and technical analysis. An investor following this strategy will research companies until a company is found that appears to be competent, sound, and looks like it should continue to prosper in the future. However, before buying stock in it, the investor looks at historic price charts to help determine the best moment to buy. Based on the price chart, the investor may decide to wait a few days, weeks or months before buying the stock.

### The Internet

The Internet is a large connection of interconnected computers. Initially developed by the United States Defense Department, it has expanded to a great variety of uses including the buying and selling of financial instruments. A significant percentage of the population in the United States and in many other countries currently has access to the Internet and uses it frequently. Internet users continue to grow rapidly.

Many companies have web sites and encourage potential customers to visit these sites. Creation of web sites is a well-developed Internet business with many people and organizations offering to create web sites. In addition, many books are available providing instructions for individuals to create their own web sites.

Web site owners use their web sites for varying purposes. Some of these purposes include advertising products or services, providing information, or for selling products or services. More specifically, in recent years the Internet has become a major means by which investors and brokers can both monitor the stock market and buy and sell stocks.

### How the Internet Helps the Investor

Although an investor does not need to be online to buy stocks, Internet access may be of great value. The Internet offers resources that are unmatched by any single print source. A wired investor can get access to literally thousands of investment services, publications, newsletters, and discussion groups from the comfort of their living room or office. In this manner an investor can quickly gather a large amount of information about various financial instruments, including information about companies whose stock may be of interest.

### The Agents: Market Makers, Specialists and Electronic Communication Networks

The stock market includes a number of features that affect the stock investor. One of these features is the existence of agents to facilitate the functioning of the market. Market makers, specialists and Electronic Communications Networks (ECNs) make market in stocks. Market makers are part of the National Association of Securities Dealers market (NASD), and specialists work on the New York Stock Exchange (NYSE) and other listed exchanges. An ECN is an electronic board where buy and sell orders may be posted by any investor worldwide. These agents serve a similar function but there are a number of differences between them.

### 1. Specialists

The New York Stock Exchange (NYSE) is the oldest stock exchange in the United States. The NYSE (as well as the Philadelphia, Chicago, Boston, and Pacific Stock Exchanges) uses an agency auction market system that is designed to allow the public to meet the public as much as possible. The majority of trading volume (approximately 90%) occurs with no intervention from the dealer. The responsibility of specialists is to make a fair and orderly market in the issues assigned to them. They must yield to public orders, which means that they may not trade for their own account when there are public bids and offers better than their own. The specialist has an affirmative obligation to eliminate imbalances of supply and demand when they occur. Specialists are required to make a continuous market. The exchange has strict guidelines for trading depth and continuity that must be observed. Specialists are subject to fines and censures if they fail to perform this function. NYSE specialists have large capital requirements and are overseen by Market Surveillance at the NYSE.

A specialist will typically maintain a narrow spread between offers to buy and offers to sell. Generally, the trader will need access to a professional's data feed before the trader can really see the size of the spread.

There are over a thousand NYSE members (i.e., seats), of which approximately a third are specialists. There are over 3000 common and preferred stocks listed on the NYSE. On the average, each specialist handles 6 issues. The very big stocks may have a specialist devoted solely to them.

Every listed stock has one firm assigned to it on the floor. Most stocks are also listed on regional exchanges in San Francisco, Chicago, Philadelphia and Boston. All NYSE trading (approximately 80% of total volume) occurs at that post on the floor of the specialist assigned to it.

### 2. Market Makers

NASDAQ is an abbreviation for the National Association of Securities Dealers Automated Quotation system. The NASDAQ market is an interdealer market represented by over 600 securities dealers trading more than 15,000 different issues. These dealers are called market makers. Unlike the NYSE, the NASDAQ market does not operate as an auction market. Instead, market makers are expected to compete against each other by posting the best quotes (best bid, i.e., best offer to buy, and best ask, i.e., best offer to sell).

A NASDAQ Level II quotation system shows all the bid offers, ask offers, size of each offer (the order size), and the market makers making the offers. The order size is simply the number of shares the market maker is prepared to fill at that price. Since about 1985 the average person has had access to Level II quotes.

The Small Order Execution System (SOES) was implemented by NASDAQ following the 1987 market crash. This system is intended to help the small investor have his or her transactions executed without allowing market makers to take advantage of the small investor. The trader may see mention of “SOES Bandits” which is slang for people who day-trade stocks on the NASDAQ using the SOES, scalping profits on the spreads.

A firm can become a market maker on NASDAQ by applying to NASD. The requirements include certain capital requirements, electronic interfaces, and a willingness to make a two-sided market. The trader must be there every day. If the trader doesn't post continuous bids and offers every day the trader can be penalized and not allowed to make a market for a month. Market makers are regulated by the NASD, which is overseen by the SEC.

The brokerage firm can handle customer orders either as a broker or as a dealer/principal. When the brokerage acts as a broker, it simply arranges the trade between buyer and seller, and charges a commission for its services. When the brokerage acts as a dealer/principal, it's either buying for or selling from its own account (to or from the customer), or acting as a market maker. The customer is charged either a mark-up or a mark-down, depending on whether they are buying or selling. The brokerage is disallowed from charging both a mark-up (or mark-down) and a commission. Whether acting as a broker or as a dealer/principal, the brokerage is required to disclose its role in the transaction. However, dealers/principals are not necessarily required to disclose the amount of the mark-up or mark-down, although most do this automatically on the confirmation as a matter of policy. Despite its role in the transaction, the firm must be able to display that it made every effort to obtain the best posted price. Whenever there is a question about the execution price of a trade, it is usually best to ask the firm to produce a Time and Sales report, which allows the customer to compare all execution prices with their own.

In NASDAQ, the public almost always meets the dealer making it nearly impossible to buy on the bid or sell on the ask. Dealers can buy on the bid even though the public is bidding. Despite the requirement of making a market, in the case of market makers there is no one firm who has to take responsibility if trading is not fair or orderly, as what seemed to have happened during the crash of 1987. At that time, many NASD firms simply stopped making markets or answering phones until the dust settled.

### 3. Electronic Communication Networks

Recently, Electronic Communication Networks (ECN) were established in order to allow investors to trade NASDAQ listed stocks without having to go through market makers, oftentimes resulting in better fills for the investor. An ECN is an electronic board where buy and sell orders may be posted by any investor worldwide. The best bid and best ask orders from the ECN are posted in the NASDAQ system alongside those of market makers.

### Bid, Ask, and Spread

If a trader wants to buy or sell a financial instrument, such as a stock or other security, in an open market, the trader normally trades via agents on the market scene who specialize in that particular security. These people stand ready to sell the trader a security for some asking price (the “ask”) if the trader would like to buy it. Or, if the trader owns the security and would like to sell it, the agent buys the security from the trader for the bid price (the “bid”). The bid and the ask prices remain until a new price is set. The difference between the current bid and the current ask is called the spread. Financial instruments that are heavily traded tend to have very narrow spreads, but financial instruments that are lightly traded may have spreads that are significant, even as high as several dollars.

The width of the spread is indicative of the financial instrument's liquidity. Liquidity basically measures the willingness of investors to buy or sell significant quantities of the financial instrument at any time. In the stock market, market makers or specialists (depending on the exchange) buy stocks from the public at the bid and sell stocks to the public at the ask (called “making a market in the stock”). At most times (unless the market is crashing, etc.) these people stand ready to make a market in most stocks and often in substantial quantities, thereby maintaining market liquidity.

Dealers make their living by taking a large part of the spread on each transaction—they normally are not long-term investors. In fact, they work a lot like the local supermarket, raising and lowering prices on their inventory as the market moves, and making a few cents here and there.

### Online Trading Over the Internet

Two types of online trading available to the public are: Internet trading provided by firms that route the trader's order to a trading desk or to a third party willing to pay for order flow; and dedicated online services provided by firms where orders go directly to the exchange yielding a quick and efficient execution.

### The Data

If the online investor uses the first type of online trading discussed above, the investor's order may be gamed by a specialist or market maker handling the order. Unfortunately, if this happens to the trader, the investor may not be able to recognize that it has happened from the minimal information typically provided in the order confirmation. Typically, the investor knows only what's called Level I data—the best bid, the best ask, the last trade, and the order size of each data respectively.

If the trader uses the second type of online trading discussed above (i.e., the order goes from the firm directly to the exchange), the trader most likely is looking at a NASDAQ Level II screen. This screen shows all the bid offers, ask offers, the recent trades, the size of each offer or trade, and the market makers and ECNs making the offers.

### Using Technical Analysis Online

An online trader connected to a web site that has a screen that displays NASDAQ Level II data, may see the following information streaming continuously on the screen: all bid offers, all ask offers, all trades, the size of each offer or trade and the market maker or ECN making the offer. This data may be refreshed as often as ten times per second. Hence, many traders end up being glued to their screen all day. Moreover, unless the trader has a prodigious memory and even then the information may arrive too quickly to be fully read, much less utilized by the trader. The more individual financial instruments monitored by the trader, the greater the difficulty in utilizing the flood incoming data. Thus, a lot of important data may escape notice. Additionally, impatience at waiting may cause the trader to make a trade at an inopportune moment. Thus, an automated means of analyzing this wealth of information is desirable.

The present invention involves methods of modeling financial markets and automating trades to take advantage of this plethora of bid and ask price data.

### SUMMARY OF THE INVENTION

An exemplary embodiment of the present invention is a method for producing a timestamped series of price data of a financial instrument from a plurality of prices of the financial instrument. The timestamped series of price data includes a timestamp associated with each price that each have a timestamp precision of one millisecond or less and a timestamp accuracy equal to or shorter than the timestamp precision. At least one timestamping processor is provided to receive the prices. The internal clock of each timestamping processor is synchronized to a universal time that has a time precision equal to or shorter than half of the timestamp precision and a time accuracy equal to or shorter than half of the timestamp precision. Each price of the financial instrument is applied to one of the timestamping processors with a predetermined time delay from the quotation of the applied price. Each predetermined time delay has a time delay precision equal to or shorter than half of the timestamp precision and a time delay accuracy equal to or shorter than half of the timestamp precision. A timestamp is determined for each applied price based on the corresponding predetermined delay time and the internal time of the timestamping processor when the price is applied.

Another exemplary embodiment of the present invention is a financial market timestamping system for producing a timestamped series of price data of a financial instrument that includes a plurality of prices and a timestamp associated with each price. Each timestamp has a timestamp precision of one millisecond or less and a timestamp accuracy equal to or shorter than the timestamp precision. The system includes at least one timestamping processor and at least one transmission line coupled to each timestamping processor. The timestamping processor(s) receive(s) the prices and provide associated timestamps for each price. Each timestamping processor includes an internal clock that Is synchronized to a universal time that has a time precision equal to or shorter than half of the timestamp precision and a time accuracy equal to or shorter than half of the timestamp precision. The transmission line(s) transmit(s) prices of the financial instrument to the coupled timestamping processor(s). Each transmission line provides a predetermined time delay between the quotation of a price and its reception by the timestamping processor. Each predetermined time delay has a time delay precision equal to or shorter than half of the timestamp precision and a time delay accuracy equal to or shorter than half of the timestamp precision. The timestamping processor(s) determine(s) the associated timestamp of each price based on the universal time the price was received and the predetermined time delay of the transmission line on which the price was transmitted.

### BRIEF DESCRIPTION OF THE DRAWINGS

The invention is best understood from the following detailed description when read in connection with the accompanying drawings. Included in the drawing are the following figures:

FIG. 1 is a schematic block diagram illustrating an exemplary financial market timestamping system according to the present invention.

FIG. 2 is a flow chart illustrating an exemplary method of producing a timestamped series of price data of a financial instrument from a plurality of prices of the financial instrument according to the present invention.

### DETAILED DESCRIPTION OF THE INVENTION

Exemplary embodiments of the present invention include methods of producing timestamped series of price data of financial instruments and financial market timestamping systems. These exemplary methods and systems may produce improved timestamped series of price data for use in technical analysis investment strategies to maintain portfolios that may include one or more different financial instruments. These financial instruments may be publicly traded financial instruments or privately traded financial instruments and may include: stocks, bonds, commodities, currencies, equity instruments, derivative securities, and/or futures.

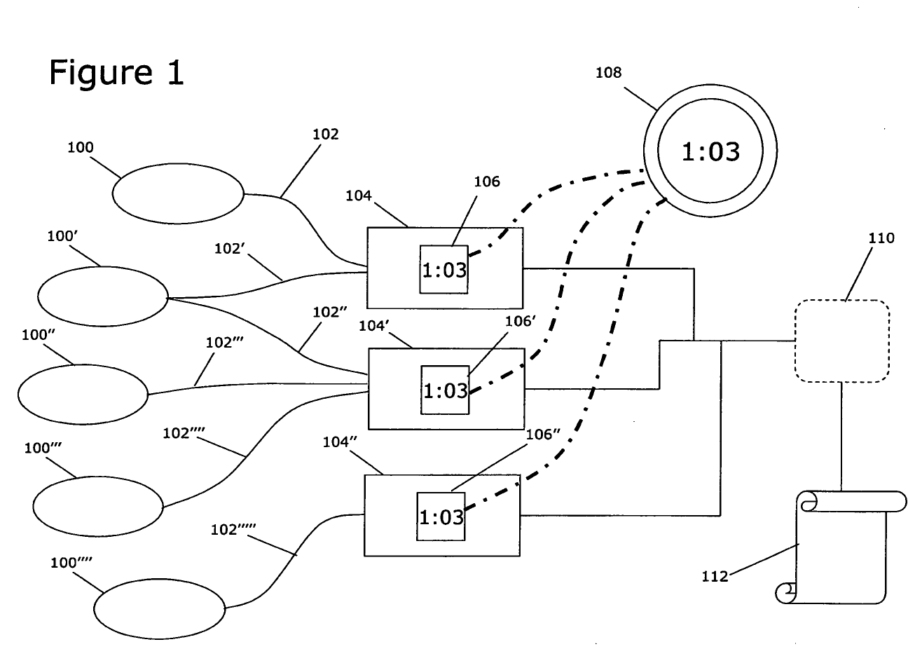

FIG. 1 illustrates an exemplary financial market timestamping system for producing timestamped series of price data 112 of a financial instrument (or financial instruments). Exemplary timestamped series of price data 112 desirably includes a plurality of prices and a timestamp associated with each price. The financial instrument prices included in exemplary timestamped series of price data 112 may includes one or more of: bid prices, ask prices, or trade prices of the financial instrument(s). These prices may represent the prices of the financial instrument(s) from one exchange 100 or from multiple exchanges 100, 100′, 100″, 100′″, and 100″″ as shown in FIG. 1.

Each timestamp determined in exemplary embodiments of the present invention has a precision of one millisecond or less and an accuracy that is equal to or shorter than the precision. Timestamp precision and accuracy of this order is desirable for use in the modeling of financial instrument prices for use in technical analysis investment strategies. Future price predictions of such models may be adversely affected by the use of either imprecise or inaccurate price data to develop the model, as well as the use of imprecise and/or inaccurate price data as the input data for the model.

Further, a lack of precise and accurate timestamped series of price data hampers analysis of financial markets for determining the performance of different trading strategies. For example, if a trader wishes to model the affect of certain trades on the price of a financial instrument, the trader may use a model of the financial instrument to replay the market for the financial instrument on the day(s) of the trades, using the precise and accurate timestamped series of price data with the trades of interest removed from the timestamped series. The trader may then compare the actual trade prices for the selected trades to various benchmarks, such as the volume weighted average price (VWAP) or the time weighted average price (TWAP) of the financial instrument for the given time period. This comparison is only as reliable as the ability of the trader to accurately replay the market, however, and this reliability is strongly affected by the precision and accuracy of the price data.

Currently, price data of many financial instruments may be obtained with timestamps quoted to the millisecond. Unfortunately, there are a number of Issues that call both the accuracy and the precision of the timestamps included in these series of price data into question. Three of these issues are: 1) a lack of synchronization between different exchanges and even between different timestamping processors within a single exchange, leading each timestamping processor to use its own internal time for the timestamps rather than a universal time; 2) uncertainty in the period of time between a price being quoted and that price receiving a timestamp, leading to timestamping processors using the arrival time at the timestamping processor rather than the actual quote time as the reported timestamp; and 3) the use of buffers in timestamping processors that aggregate price data and then timestamp a number of price data simultaneously. It is noted that the use of buffers to aggregate price data for simultaneous timestamping may allow for sufficient precision to be maintained, but does not always preserve the quote order during periods that have a particularly high volume of price data, such as at the daily opening of an exchange.

Exemplary embodiments of the present invention address each of these issues. As illustrated in FIG. 1, quotes and/or prices from one or more exchanges 100, 100′, 100−, 100′″, and 100′′ are transmitted to timestamping processors 104, 104′, and 104″ over transmission lines 102, 102′, 102″, 102′″, 102″″ and 102′″″. Each transmission line couples one exchange to one timestamping processor and provides a predetermined time delay between the quotation of a price at the exchange and the reception of the price by the timestamping processor. The predetermined time delay of the transmission line has to be reproducible, with a time delay precision equal to or shorter than half of the desired timestamp precision and a time delay accuracy equal to or shorter than half of the desired timestamp precision. Additionally, depending on the expected use of the timestamped series of price data 112, it may be desirable for delay time of the transmission line to be as short as possible.

Transmission lines 102, 102′, 102″, 102′″, 102″″ and 102′″″ may include a number of different types of means of transmitting the price data, such as: fiber optic transmission lines; hard wired electrical connections; microwave communication links; radio frequency communication links; free-space laser communication links; or combinations thereof. However, these transmission lines are desirably not packet switched communication networks. Due to the redundancy and multiple pathways of packet switched networks, such as the internet, it is not possible to maintain a predetermined time delay having the desired sub-millisecond accuracy and precision over such a network.

As shown in FIG. 1, it is contemplated that a single timestamping processor (such as timestamping processors 104 and 104′ shown in FIG. 1) may receive price data from more than one exchange over more than one transmission line. It is noted that these transmission lines may become combined before reaching the timestamping processor. For example, transmission line 102 may include a microwave communication link to transmitted price data from exchange 100 to a transceiver and transmission line 102′ may include another microwave communication link to transmitted price data from exchange 100′ to the transceiver. The transceiver may then multiplex the two sets of price data and transmit the multiplexed price data along a fiber optic transmission line to timestamping processor 104. In this example, transmission line 102 includes the first microwave communication link, the transceiver, and the fiber optic transmission line, and transmission line 102 includes the other microwave communication link, the transceiver, and the fiber optic transmission line. As long as the predetermined delay may be determined with the desired accuracy and precision, such transmission line configurations are acceptable.

Additionally, it is contemplated that there may be more than one timestamping processor receiving price data from a single exchange (such as exchange 100′ shown in FIG. 1) over separate transmission lines. This may be particularly useful for exchanges with high volumes of price data, which may not be able to be handled by a single timestamping processor. As noted in above, the separate transmission lines may include common portions. For example, transmission lines 102′ and 102″ may include a hard wired electrical connection to transmit a high bit rate stream of price data from exchange 100′ to an inverse multiplexer that separates the price data from exchange 100′ into two lower bit rate streams of price data. The first lower bit rate stream of price data continues along transmission line 102′ (perhaps via a radio frequency communication link) to timestamping processor 104, while the second lower bit rate stream of price data continues along transmission line 102″ (perhaps via a free-space laser communication link) to timestamping processor 104′. The inverse multiplexer may separate the high bit rate stream of price data based on a number of criteria. For example, the inverse multiplexer may separate the price data such bid prices are sent to one timestamping processor (a bid timestamping processor) and ask prices are sent to another timestamping processor (an ask timestamping processor), or the price data may be separated based on different financial instruments. Alternatively, the inverse multiplexer may separate the price data so that it is evenly distributed between the timestamping processors.

Each timestamping processor includes an internal clock that is synchronized to a universal time provided by universal clock 108 (i.e. timestamping processor 104 includes internal clock 106, timestamping processor 104′ includes internal clock 106′, and timestamping processor 104″ includes internal clock 106″). The universal time desirably has a precision and an accuracy that is equal to or shorter than half of the desired timestamp precision and accuracy, respectively. This way, when the predetermined time delay of the transmission line is subtracted from the universal time at the receipt of the price data, the resulting time to be used for the timestamp may have a precision and accuracy less than or equal to the desired timestamp precision and accuracy, respectively.

The timestamping processors may be adapted to receive one or more types of time signals from universal clock 108 so that their internal clocks may be resynchronized regularly. These time signals may include global positioning system (GPS) signals, code division multiple access (CDMA) cellular signals, or other types of signals that may be used to precisely and accurately synchronize the internal clocks to the universal time. Alternatively, the internal clocks may be highly precise and accurate clocks, such as atomic clocks that may maintain the desired level of synchronization to the universal time over extended periods of time. Such clocks may be resynchronized, only as needed, by a comparison to the universal clock.

The timestamping processor(s) determine(s) the associated timestamp of each price based on the universal time the price was received and the predetermined time delay of the transmission line on which the price was transmitted. Once each price is associated with a timestamp, the resulting prices and timestamps may be used as the series of timestamped price data 112 without further processing; however, it may be desirable for the series of time stamped price data 112 to be ordered by the timestamps. If the untimestamped price data is based on quotes that originate from a single exchange and this price data is transmitted over a single transmission line to a single timestamping processor, the resulting series of timestamped price data 112 is likely to be ordered by Its timestamps already. If the untimestamped price data comes from multiple exchanges and/or transmission lines, however, it is likely that the series of timestamped price data is not ordered by its timestamps when it is generated even if a single timestamping processor generates the series. Also, if multiple timestamping processors are used it Is desirable to combine the sub-series of timestamped price data generated by each timestamping processor to create the series of timestamped price data 112.

FIG. 1 illustrates an alternative additional element, series processor 110 (shown in broken lines). Series processor 110 may be used to process the timestamped price data generated by timestamping processors 104, 104′, and 104″ to form the series of timestamped price data 112. Series processor 110 may include portions to perform a number of different procedures, including: reordering the timestamped price data, so that series of timestamped price data 112 is ordered by the timestamps no matter from which exchange the price data originated; flagging the timestamped price data of a financial instrument based on various categories, such as bid prices, ask prices, trade prices, etc. and/or separating the timestamped price data into different sub-series on these bases; and flagging the timestamped price data of different financial instrument and/or separating the timestamped price data into different sub-series on these bases.

Additionally, series processor 110 may include perform calculations on the timestamped price data. For example, timestamping processor 104 may be a bid timestamping processor adapted to timestamp bid prices from exchange 100′ and timestamping processor 104′ may be an ask timestamping processor adapted to timestamp ask prices from exchange 100′. Series processor 110 may include a bid series processor coupled to bid timestamping processor 104 to form a sub-series of timestamped bid price data from the bid prices and associated timestamps, and an ask series processor coupled to ask timestamping processor 104′ to form a sub-series of timestamped ask price data from the ask prices and associated timestamps. A sub-series of timestamped price spread data may be formed from the sub-series of timestamped bid price data and the sub-series of timestamped ask price data. The series of timestamped price data 112 may include any or all of these sub-series.

Because the price data transmitted to series processor 110 has already been timestamped, it is noted that is may not be critical for the transmission line(s) between the timestamping processor(s) and series processor 110 to have particularly precise or accurate time delays. Thus, a packet switched network could be used; however, for some applications, it may be desirable to minimize the time delay between quotation of the prices and reporting the timestamped prices in the series of timestamped price data 112, which may make it undesirable to use a packet switched network at any point in the transmission of the price data.

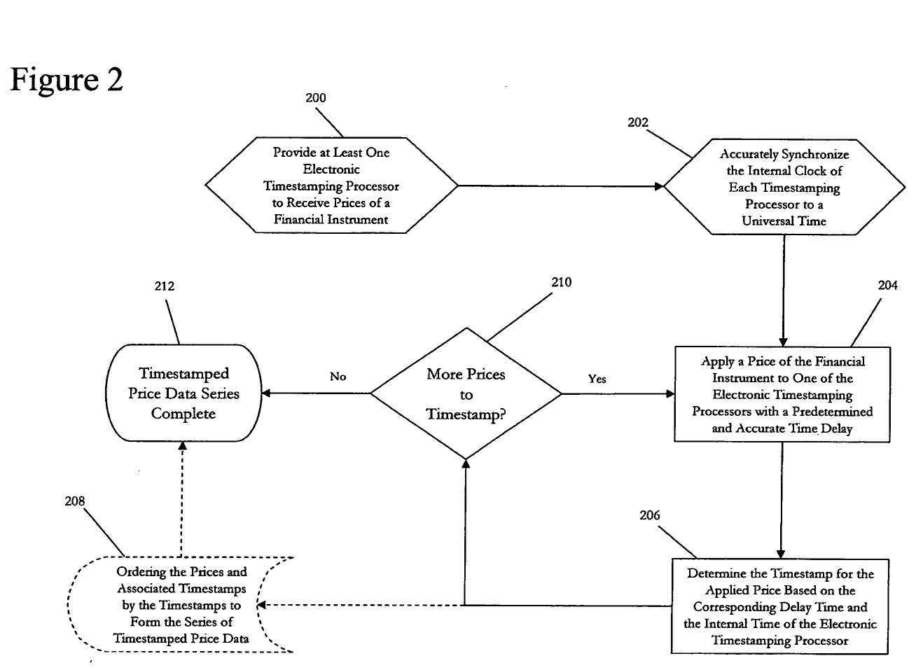

FIG. 2 illustrates an exemplary method for producing a timestamped series of price data of a financial instrument from a plurality of prices of the financial instrument. The timestamped series of price data includes a timestamp associated with each price. Each timestamp desirably has a precision of one millisecond or less and an accuracy that is equal to or shorter than the precision. This exemplary method may desirably use a timestamping system similar to the exemplary timestamping system of FIG. 1. As described above with reference to FIG. 1, the price data may include a number of different types of price data including bid prices, ask prices, trade prices, and price spreads among others.

At least one timestamping processor is provided to receive the plurality of prices, step 200. These prices may come from a number of different exchanges. It may be desirable for each timestamping processor to receive prices from only one of these exchanges. Alternatively, it may be desirable for each timestamping processor to receive only one type of price, i.e. bid prices, ask prices, or trade prices; or to receive price data for only one specific financial instrument.

The internal clock of each timestamping processor is synchronized to a universal time, which has a time precision and a time accuracy that are each equal to or shorter than half of the desired precision of the timestamps, step 202. The internal clock(s) may be synchronized by first initializing a universal clock to maintain the universal time, and then synchronizing the internal clock(s) to the universal time, using this universal clock. Alternatively, the internal clock of each timestamping processor may be synchronized to the universal time using GPS signals or CDMA cellular signals.

A price of the financial instrument is applied to a timestamping processor with a predetermined time delay from the quotation of the applied price, step 204. Different prices may have different time delays depending on the transmission line used to transmit the exchange to the timestamping processor; however, the predetermined time delay associated with each transmission line has a precision and accuracy equal to or shorter than half of the desired precision of the timestamp.

The timestamp for the applied price is determined based on the corresponding predetermined delay time and the internal time of the one timestamping processor when the price is applied, step 206. It is then determined whether there are more prices to be timestamped, step 210. Steps 204 and 206 are repeated for each price to be timestamped. If the price data is a continuous stream of price data, such as a stream of current bid prices, then this loop is repeated continually. If there is a finite amount of price data, then once the last price is timestamped the timestamped price data series is complete and this loop is finished, step 212.

As the series of timestamped price data is generated it may be desirable to order the prices and associated timestamps by the timestamps to form the series of timestamped price data, step 208 (shown in broken lines). As described above with reference to FIG. 1, the prices and associated timestamps from each timestamping processor may be transmitted to a series processor for this ordering. The series processor compares the timestamps to determine an order of the price data as they are received and orders the prices and associated timestamps based on this comparison. Also as described above with reference to FIG. 1, the series processor may perform other processing of the timestamped price data, such as separating the price data into various sub-series and/or calculating additional timestamped price data such as a sub-series of timestamped price spreads.

Elements of the various exemplary embodiments of the present invention may be carried out through the use of a general-purpose computer system programmed to perform the corresponding steps of the exemplary methods described above with reference to FIGS. 1 and 2. Exemplary general-purpose computer systems may include personal computers, work stations, distributed processing computer networks, and parallel processing computer systems. Parallel or distributed processing may be desirable for substantially real time applications involving the substantially concurrent prediction of future quotes for a plurality of financial instruments. Dedicated special-purpose circuitry and computing systems may also be designed for performing exemplary methods of the present invention as well.

Although the invention is illustrated and described herein with reference to specific embodiments, the invention is not intended to be limited to the details shown. Rather, various modifications may be made in the details within the scope and range of equivalents of the claims and without departing from the invention.

1. A method for producing a timestamped series of price data of a financial instrument from a plurality of prices of the financial instrument, the timestamped series of price data includes a timestamp associated with each price, each timestamp having a timestamp precision of one millisecond or less and a timestamp accuracy equal to or shorter than the timestamp precision, the method comprising the steps of:
a) providing at least one timestamping processor to receive the plurality of prices;
b) synchronizing an internal clock of each timestamping processor to a universal time, the universal time having a time precision equal to or shorter than half of the timestamp precision and a time accuracy equal to or shorter than half of the timestamp precision;
c) applying each price of the financial instrument to one of the at least one timestamping processors such that the applied price is applied to the one timestamping processor with a predetermined time delay from the quotation of the applied price, each predetermined time delay having a time delay precision equal to or shorter than half of the timestamp precision and a time delay accuracy equal to or shorter than half of the timestamp precision;
d) determining a timestamp for the applied price based on the corresponding predetermined delay time and the internal time of the one timestamping processor; and
e) repeating steps (c) and (d) for each price of the plurality of prices.

2. The method according to claim 1, wherein the financial instrument is a publicly traded financial instrument.

3. The method according to claim 1, wherein the plurality of prices of the financial instrument includes prices from a plurality of exchanges.

4. The method according to claim 3, wherein each of the timestamping processors provided in step (a) receives the prices from one of the plurality of exchanges.

5. The method according to claim 1, wherein the financial instrument is one of a stock, a bond, a commodity, a currency, an equity instrument, a derivative security, or a future.

6. The method according to claim 1, wherein the plurality of prices of the financial instrument includes at least one of: a plurality of bid prices, a plurality of ask prices, or a plurality of trade prices.

7. The method according to claim 1, wherein the plurality of prices of the financial instrument include a plurality of bid prices and a plurality of ask prices.

8. The method according to claim 7, wherein:
the at least one timestamping processor is a plurality of timestamping processors;
a bid subset of the plurality of timestamping processors provided in step (a) receives the plurality of bid prices; and
an ask subset of the plurality of timestamping processors provided in step (a) receives the plurality of ask prices.

9. The method according to claim 7, wherein the plurality of prices of the financial instrument further include a plurality of trade prices.

10. The method according to claim 9, wherein:
the at least one timestamping processor is a plurality of timestamping processors;
a bid subset of the plurality of timestamping processors provided in step (a) receives the plurality of bid prices;
an ask subset of the plurality of timestamping processors provided in step (a) receives the plurality of ask prices; and
a trade subset of the plurality of timestamping processors provided in step (a) receives the plurality of trade prices.

11. The method according to claim 1, wherein step (b) includes synchronizing the internal clock of each timestamping processor to the universal time using at least one of:
a plurality of global positioning system (GPS) signals; or
a plurality of code division multiple access (CDMA) cellular signals.

12. The method according to claim 1, wherein step (b) includes:
b1) initializing a universal clock to maintain the universal time; and
b2) synchronizing the internal clock of each timestamping processor to the universal time using the universal clock.

13. The method according to claim 1, further comprising the step of:
f) ordering the prices and associated timestamps by the timestamps to form the series of timestamped price data.

14. The method according to claim 13, wherein step (f) includes:
f1) transmitting the prices and associated timestamps from each timestamping processor to a series processor;
f2) comparing the timestamps received by the series processor to determine an order of the price data; and
f3) ordering the prices and associated timestamps by the timestamps to form the series of timestamped price data.

15. The method according to claim 13, wherein:
the plurality of prices of the financial instrument includes a plurality of bid prices and a plurality of ask prices;
the at least one timestamping processor is a plurality of timestamping processors;
a bid subset of the plurality of timestamping processors provided in step (a) receives the plurality of bid prices;
an ask subset of the plurality of timestamping processors provided in step (a) receives the plurality of ask prices;
the series of timestamped price data includes a series of timestamped bid price data and a series of timestamped ask price data; and
step (f) includes the steps of:
f1) transmitting the bid prices and associated timestamps from the bid subset of timestamping processors to a bid series processor;
f2) comparing the timestamps received by the bid series processor to determine an order of bid price data;
f3) ordering the bid prices and associated timestamps by the timestamps to form the series of timestamped bid price data;
f4) transmitting the ask prices and associated timestamps from the ask subset of timestamping processors to an ask series processor;
f5) comparing the timestamps received by the ask series processor to determine an order of ask price data; and
f6) ordering the ask prices and associated timestamps by the timestamps to form the series of timestamped ask price data.

16. The method according to claim 13, wherein:
the plurality of prices of the financial instrument includes a plurality of bid prices and a plurality of ask prices;
the at least one timestamping processor is a plurality of timestamping processors;
a bid subset of the plurality of timestamping processors provided in step (a) receives the plurality of bid prices;
an ask subset of the plurality of timestamping processors provided in step (a) receives the plurality of ask prices;
the series of timestamped price data includes a series of timestamped price spread data; and
step (f) includes the steps of:
f1) transmitting the bid prices and associated timestamps from the bid subset of timestamping processors to a bid series processor;
f2) comparing the timestamps received by the bid series processor to determine an order of bid price data;
f3) ordering the bid prices and associated timestamps by the timestamps to form a series of timestamped bid price data;
f4) transmitting the ask prices and associated timestamps from the ask subset of timestamping processors to an ask series processor;
f5) comparing the timestamps received by the ask series processor to determine an order of ask price data;
f6) ordering the ask prices and associated timestamps by the timestamps to form the series of timestamped ask price data;
f7) transmitting the series of timestamped bid price data and the series of timestamped ask price data to a spread series processor; and
f8) determining the series of timestamped price spread data from the series of timestamped bid price data and the series of timestamped ask price data.

17. The method according to claim 13, wherein:
the plurality of prices of the financial instrument includes a plurality of bid prices and a plurality of ask prices;
the plurality of prices of the financial instrument further includes a plurality of trade prices;
the at least one timestamping processor is a plurality of timestamping processors;
a bid subset of the plurality of timestamping processors provided in step (a) receives the plurality of bid prices;
an ask subset of the plurality of timestamping processors provided in step (a) receives the plurality of ask prices; and
a trade subset of the plurality of timestamping processors provided in step (a) receives the plurality of trade prices;
the series of timestamped price data includes a series of timestamped bid price data, a series of timestamped ask price data, and a series of timestamped trade price data; and
step (f) includes the steps of:
f1) transmitting the bid prices and associated timestamps from the bid subset of timestamping processors to a bid series processor;
f2) comparing the timestamps received by the bid series processor to determine an order of bid price data;
f3) ordering the bid prices and associated timestamps by the timestamps to form the series of timestamped bid price data;
f4) transmitting the ask prices and associated timestamps from the ask subset of timestamping processors to an ask series processor;
f5) comparing the timestamps received by the ask series processor to determine an order of ask price data;
f6) ordering the ask prices and associated timestamps by the timestamps to form the series of timestamped ask price data;
f7) transmitting the trade prices and associated timestamps from the trade subset of timestamping processors to a trade series processor;
f8) comparing the timestamps received by the trade series processor to determine an order of trade price data; and
f9) ordering the trade prices and associated timestamps by the timestamps to form the series of timestamped trade price data.

18. The method according to claim 13, wherein:
the plurality of prices of the financial instrument includes a plurality of bid prices and a plurality of ask prices;
the series of timestamped price data includes a series of timestamped price spread data;
step (d) further includes flagging the applied price with a bid flag if the applied price is a bid price and flagging the applied price with an ask flag if the applied price is an ask price; and
step (f) includes the steps of:
f1) comparing the timestamps to determine an order of price data;
f2) ordering the prices, associated timestamps, and associated flags by the timestamps to form a series of timestamped bid/ask price data; and
f3) calculating the series of timestamped price spread data from the series of timestamped bid/ask price data.

19. A financial market timestamping system for producing a timestamped series of price data of a financial instrument that includes a plurality of prices and a timestamp associated with each price and each timestamp having a timestamp precision of one millisecond or less and a timestamp accuracy equal to or shorter than the timestamp precision, the financial market timestamping system comprising:
at least one timestamping processor to receive the plurality of prices and provide associated timestamps for each price, each timestamping processor including an internal clock that is synchronized to a universal time, the universal time having a time precision equal to or shorter than half of the timestamp precision and a time accuracy equal to or shorter than half of the timestamp precision; and
at least one transmission line coupled to each timestamping processor to transmit prices of the financial instrument to the coupled timestamping processors, each transmission line providing a predetermined time delay between a quotation of a price and reception of the price by the timestamping processor, each predetermined time delay having a time delay precision equal to or shorter than half of the timestamp precision and a time delay accuracy equal to or shorter than half of the timestamp precision;
wherein the at least one timestamping processor determines the associated timestamp of each price based on the universal time the price was received and the predetermined time delay of the transmission line on which the price was transmitted.

20. The financial market timestamping system according to claim 19, wherein the financial instrument is a publicly traded financial instrument.

21. The financial market timestamping system according to claim 20, wherein the plurality of prices of the financial instrument includes prices from a plurality of exchanges.

22. The financial market timestamping system according to claim 21, wherein:
the at least one timestamping processor is a plurality of timestamping processors; and
each timestamping processor receives the prices from one of the plurality of exchanges.

23. The financial market timestamping system according to claim 19, wherein the financial instrument is one of a stock, a bond, a commodity, a currency, an equity instrument, a derivative security, or a future.

24. The financial market timestamping system according to claim 19, wherein the plurality of prices of the financial instrument includes at least one of: a plurality of bid prices, a plurality of ask prices, or a plurality of trade prices.

25. The financial market timestamping system according to claim 19:
wherein the at least one timestamping processor is a plurality of timestamping processors; and
the financial market timestamping system further comprises a series processor coupled to the plurality of timestamping processors to form the series of timestamped bid price data from the prices and associated timestamps determined by the timestamping processors.

26. The financial market timestamping system according to claim 19, wherein the at least one timestamping processor includes:
at least one bid timestamping processor to timestamp a plurality of bid prices; and
at least one ask timestamping processor to timestamp a plurality of ask prices.

27. The financial market timestamping system according to claim 26, further comprising:
a bid series processor coupled to the at least one bid timestamping processor to form a series of timestamped bid price data from the bid prices and associated timestamps; and
an ask series processor coupled to the at least one ask timestamping processor to form a series of timestamped ask price data from the ask prices and associated timestamps.

28. The financial market timestamping system according to claim 27, further comprising a spread series processor coupled to the bid series processor and the ask series processor to form a series of timestamped price spread data from the series of timestamped bid price data and the series of timestamped ask price data.

29. The financial market timestamping system according to claim 19:
wherein:
the plurality of prices of the financial instrument includes a plurality of bid prices and a plurality of ask prices; and
the series of timestamped price data includes a series of timestamped price spread data; and
the financial market timestamping system further comprises:
a bid/ask flagging processor coupled to the at least one transmission line to flag the applied price with a bid flag if the applied price is a bid price and to flag the applied price with an ask flag if the applied price is an ask price; and
a spread series processor coupled to the at least one timestamping processor to determine a series of timestamped price spread data from the prices, associated timestamps, and associated flags.

30. The financial market timestamping system according to claim 19, wherein each timestamping processor is adapted to:
receive a plurality of signals including at least one of:
a plurality of global positioning system (GPS) signals; or
a plurality of code division multiple access (CDMA) cellular signals; and synchronize the internal clock using the received plurality of signals.

31. The financial market timestamping system according to claim 19, wherein the internal clock of each timestamping processor includes an atomic clock.

32. The financial market timestamping system according to claim 19, wherein the at least one transmission line include at least one of: a fiber optic transmission line; a hard wired electrical connection; a microwave communication link; a radio frequency communication link; or a free-space laser communication link.
